(19) United States
(12) Patent Application Publication
(10) Pub. No.: US 2012/0197618 A1
(43) Pub. Date: Aug. 2, 2012

(54) ARCHITECTURE AND METHOD FOR REALISTIC VEHICULAR NETWORKING AND APPLICATIONS VISUALIZATION

(75) Inventors: Marcus Pang, Manalapan, NJ (US); Wai Chen, Basking Ridge, NJ (US); Jasmine Chennikara-Varghese, Somerset, NJ (US); Yibei Ling, Belle Mead, NJ (US); Rama Vuyyuru, Somerset, NJ (US); Junichiro Fukuyama, Union, NJ (US)

(73) Assignees: Toyota InfoTechnology Center, U.S.A., Inc., Mountain View, CA (US); Telcordia Technologies, Inc., Piscataway, NJ (US)

(21) Appl. No.: 13/015,544

(22) Filed: Jan. 27, 2011

(51) Int. Cl. G06G 7/76

(52) U.S. Cl. 703/8

(57) ABSTRACT

A system and method for vehicular networking and applications visualization comprises selecting a simulation area, converting the selected simulation area to graph representation, eliminating streets outside the simulation area, generating, using the graph representation, vehicles and random vehicle traffic in the simulation area, calculating vehicle movement in coordinates, transforming the calculated coordinates into a format compatible with a general purpose communication networking simulation tool, simulating, using the transformed calculated coordinates and the general purpose communication networking simulation tool, an application, and performing visualization of the simulation. The application can be local traffic information, the vehicle movement and communication among the vehicles. The simulation can be at least 2000 seconds and communication can be disruption tolerant. The visualization of the simulation can comprise a global view of all vehicles and one or more local views, each local view of one vehicle. The simulation area can be selected from a geographic map.

### FIELD OF THE INVENTION

This invention relates to systems and methods for simulating vehicle mobility, vehicular networking and in-vehicle applications. More specifically, the present invention enables the visualization of all vehicles under simulation, as well as the visualization of in-vehicle applications of individual vehicles.

### BACKGROUND OF THE INVENTION

Previous works on vehicular networking simulation have been focusing on near-instantaneous communication among the vehicles, on the order of milliseconds. An example is “electronic brake light” where vehicles send messages to nearby vehicles when the driver hits the brake. Most research for near-instantaneous communication effort focuses on the communication aspects and not on the application.

The nature of the vehicular applications for near-instantaneous communication is very different from disruption tolerant communication. In addition, for simulations involving a relatively small number of vehicles and short durations, a bird's eye view of the simulation area is not a necessity.

Simulation of Urban MObility (SUMO) is a vehicle mobility generator that enables users to visualize movements of simulated vehicles. However, SUMO lacks a communication networking simulator and cannot visualize in-vehicle applications of individual vehicles. In short, SUMO only generates vehicular traffic. QualNet is a general purpose networking communication simulation tool. However, QualNet lacks realistic vehicle mobility models and cannot display simulated vehicles on a map. QualNet allows simulation of an in-vehicle application, but lacks the ability to visualize the in-vehicle application.

Both SUMO and QualNet provide pieces of a solution to the problem of vehicular networking simulation of large, long simulations, but even together, these tools fail to solve the problem completely. For example, neither provides the visualization tool needed to visualize both the global and local views.

Accordingly, there exists a need for a vehicular networking simulation that provides visualization of the global view as well as the local view, and that addresses disruption tolerant communication and large networks requiring long simulations.

### SUMMARY OF THE INVENTION

A vehicular network can focus on a mode of communication that may take seconds or even minutes for packet delivery. To verify this kind of vehicular communication, long simulations involving a large number of vehicles, e.g., over 500, over a large area are needed. The time duration for this long simulation often is relatively long, e.g., 2,000 seconds. In such a simulation, having a global view of the simulation area that enables the user to keep track of vehicular movement and data exchanges becomes very important. A system and method to simulate, for a large number of vehicles and a long simulation time, and visualize simulated vehicle movements, vehicular networking and an in-vehicle application running in individual vehicles is presented to solve these and other problems.

In one aspect, a method for vehicular networking and applications visualization comprises selecting a simulation area, converting the selected simulation area to graph representation, eliminating streets outside the selected simulation area, generating, using the graph representation, a plurality of vehicles and random vehicle traffic in the selected simulation area, calculating vehicle movement in coordinates, transforming the calculated coordinates into a format compatible with a general purpose communication networking simulation tool, simulating, using the transformed calculated coordinates and the general purpose communication networking simulation tool, an application, and performing visualization of the simulation.

In one aspect, a system for vehicular networking and applications visualization, comprises a CPU, and a module operable to select a simulation area, convert the selected simulation area to graph representation, eliminate streets outside the selected simulation area, generate, using the graph representation, a plurality of vehicles and random vehicle traffic in the selected simulation area, calculate vehicle movement in coordinates, transform the calculated coordinates into a format compatible with a general purpose communication networking simulation tool, simulate, using the transformed calculated coordinates and the general purpose communication networking simulation tool, an application, and perform visualization of the simulation.

In one aspect of the system and method, the application is the vehicle movement and communication among the plurality of vehicles. In one aspect of the system and method, the simulation is at least two thousand (2,000) seconds and the communication is disruption tolerant. In one aspect of the system and method, the visualization of the simulation comprises a global view of all of the plurality of vehicles and one or more local views, each local view of one of the plurality of vehicles. In one aspect of the system and method, the plurality of vehicles is at least five hundred (500) vehicles. In one aspect, the simulation area is obtained from a geographic map.

A computer readable storage medium storing a program of instructions executable by a machine to perform one or more methods described herein also may be provided.

### BRIEF DESCRIPTION OF THE DRAWINGS

These and other features, benefits, and advantages of the present invention will become apparent by reference to the following figures, with like reference numbers referring to like structures across the views, wherein:

FIG. 1 shows a global view of simulation visualization in the present invention.

FIG. 2 shows a local view of simulation visualization in the present invention.

FIG. 3 shows the system architecture in an embodiment of the present invention.

FIG. 4 is a flow diagram of the vehicular networking and applications visualization process.

FIG. 5 shows the visualization creation process in one embodiment of the present invention.

### DETAILED DESCRIPTION

While simulation tools exist for visualizing movement of simulated vehicles, none integrates (a) visualization of all simulated vehicles (global view), (b) simulation of vehicular networking among the simulated vehicles, and (c) visualization of in-vehicle application in the individual simulated vehicles (local view). The novel system and method presented herein brings vehicular networking simulation to a new level by, inter alia, displaying or presenting visualization of both the global and local views of the simulation.

In accordance with the inventive technology, vehicular networking protocols and in-vehicle applications can be simulated together in a “realistic” roadway area with the use of maps from the Topologically Integrated Geographic Encoding and Referencing system (TIGER®), using vehicles with realistic mobility behavior models. Hence users can visualize both the “whole picture” or global view of all of the vehicles in the simulation, and the in-vehicle application or local view running in the vehicles (“tagged vehicles”) of their choice. The invention is not limited to maps from TIGER®; other sources of maps can also be used.

The nature of the vehicular applications for near-instantaneous communication is very different from disruption tolerant or delay tolerant communication accommodated in the present invention. Effective dissemination of information over a large roadway area where communication is frequently disrupted is problematic. Moreover, there are more varieties of interesting applications that can be simulated, like a decentralized traffic information system, based on the invention presented herein.

In addition, having multiple local views of an in-vehicle application enables users to visualize and observe how the application is working among a number of vehicles. Previous works mostly focused on just the networking aspect and few integrated the application layer.

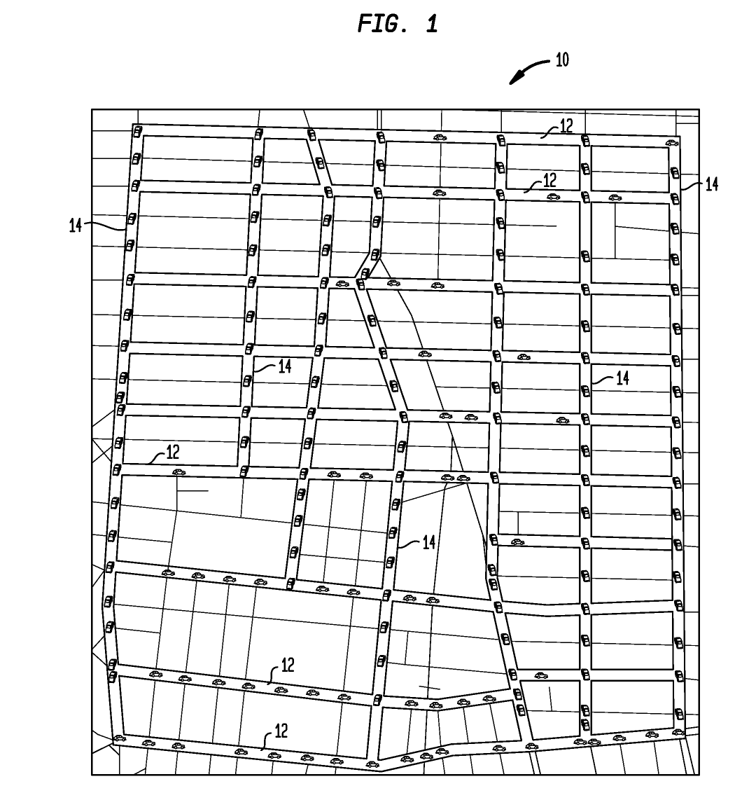

FIG. 1 shows the visualization of the overall simulation on a monitor, that is, the global view showing a map of the selected simulation area 10 with all of the vehicles scattered on it. Each vehicle's movement is randomly generated, in accordance with a Random Traffic Generator developed by the inventors, and confined to the streets displayed, e.g., the simulation area. The streets are two-way streets and may have multiple lanes each way (direction). For example, FIG. 1 shows an area with cars simulated on ten east-west (left to right) streets 12 and seven north-south (top to bottom) streets 14.

All vehicles comply with the car-following model, that is, exhibit car following behavior and lane change behavior in accordance with the car-following model, and obey (invisible) traffic lights that are assumed to be present at all intersections on the map. These features create a realistic vehicle mobility simulation on a “real” map. Other simulations require all streets to be either parallel or perpendicular to each other, and to be straight; no bends are permitted. As the vehicles move in the inventive simulation, concentric circles (not shown) representing radio communication emanate from the vehicles as they exchange information with other vehicles.

The car-following model is a microscopic simulation model of vehicular traffic, which describes the one-by-one following process of vehicles in the same lane. The car-following model embodies the human factors and reflects the real traffic situation in a better way than other traffic-flow models.

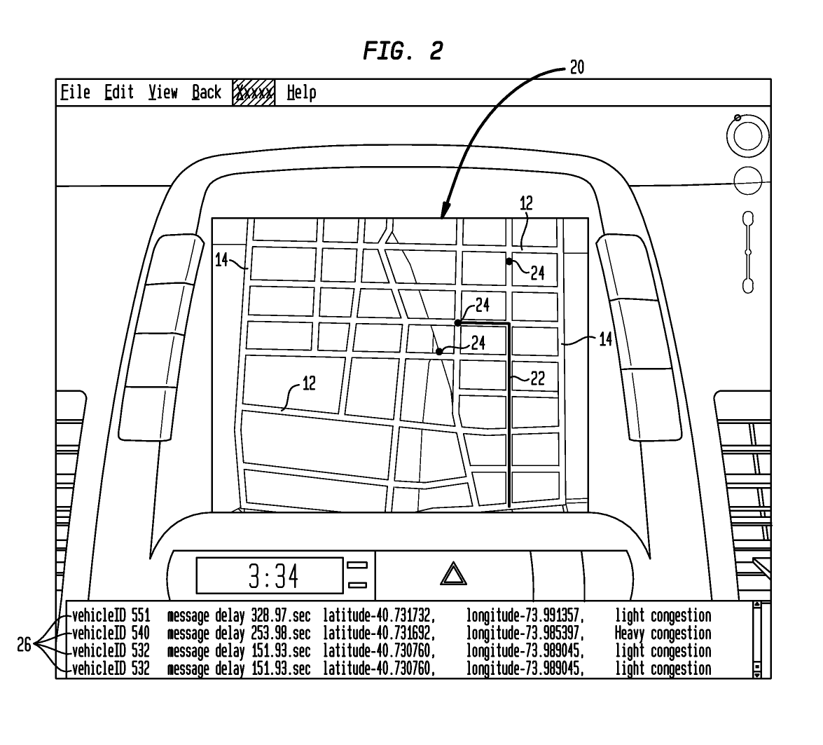

FIG. 2 shows a local view 20, that is, the visualization of an application, e.g., the map of the simulation area and the vehicles therein, running in a tagged vehicle. This local view can also be called a dashboard view since it can be displayed on a vehicle's dashboard. Multiple local views can be displayed for multiple vehicles on one or more monitors or dashboards, if so desired. Path 22 shows the route planned for the tagged vehicle. Congestion spots 24 can be displayed in color, such as red for heavy congestion and orange for lesser congestion. In one embodiment, if car speed is less than three miles per hour, the car sends a heavy congestion message, and if the car speed is greater than three miles per hour but less than ten miles per hour, the car sends a mild congestion message. In another embodiment, a car speed of less than five miles per hour can be heavy congestion; the invention is not limited to congestion defined at any particular speed. The bottom of the window of the local view 20 illustrated in FIG. 2 shows messages 26 received by the tagged vehicle. Accordingly, the user is able to see how the application reacts as messages are received and processed. The example application shown in FIGS. 1 and 2 is a traffic information system, but the invention is not limited to this type of application.

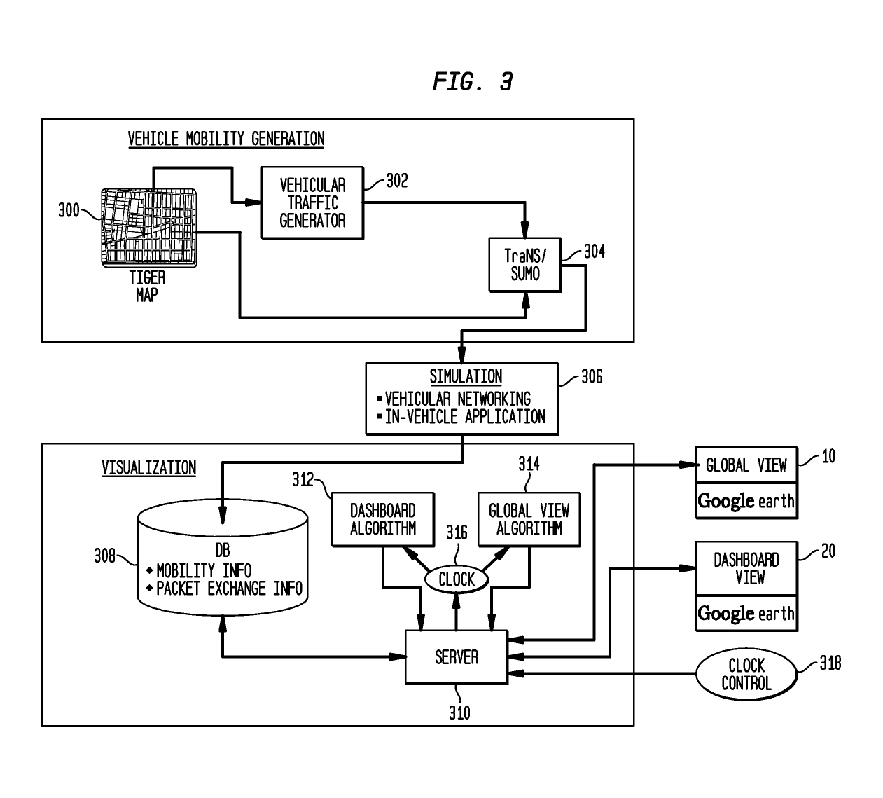

FIG. 3 shows the system architecture in an embodiment of this invention. The top portion illustrates the steps for producing the visualization. An area in which the simulation is to be run is selected. Street information is extracted from a TIGER® map 300 of the area; in one embodiment, the TIGER® map 300 can reside on a server accessible using a processor (not shown). Then a vehicular traffic generator 302 having off-the-shelf 304 as well as in-house developed software tools can be used to generate vehicle traffic on the map. In one embodiment, the off-the-shelf tools 304 include Traffic and Network Simulation Environment (TraNS) and SUMO. This vehicle traffic information is fed to a network simulator 306 that also simulates the in-vehicle application. The output of the simulation are (i) packet exchange information and (ii) in-vehicle application states, which are then fed to the visualization platform.

The visualization platform consists of a database 308 for storage of at least packet exchange information and in-vehicle application states, and a server 310 to feed display information to the audience views, e.g., the global 10 and local 20 views. A CPU (not shown) can control aspects of the server. For the global and (multiple) local views to be synchronized, a common clock 312 can be included in the visualization platform. The common clock 312 can be used to drive the data feeds to the global view algorithm 314 and the dashboard algorithm 316 which produce the audience views. Further, a clock control mechanism 318 can be provided to enable the designer to control the speed of the visualization. In one embodiment, Google® Earth can be used to display both the global and local views.

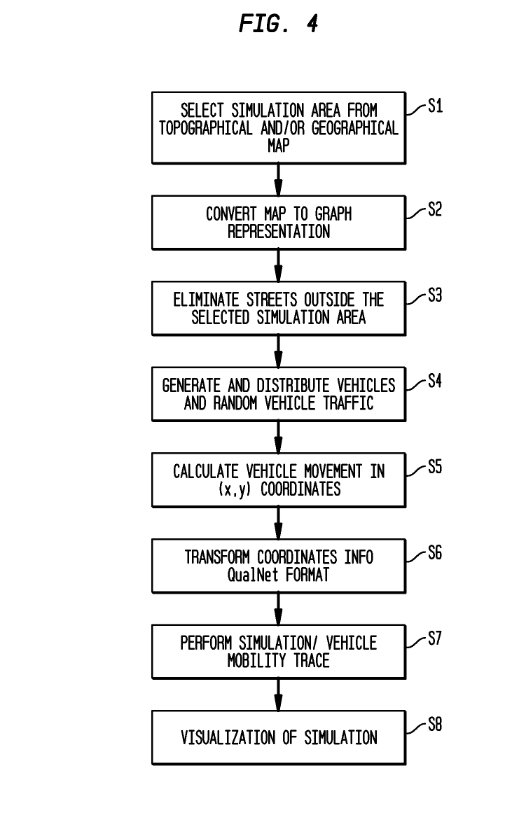

FIG. 4 is a flow diagram of the visualization creation process in detail. Initially a simulation area is selected from a geographical map, in step S1. In one embodiment, this area can be selected through TIGER® map. After the selection of a simulation area, in step S2, the map of the selected area is converted into a graph representation. In one embodiment, software such as SUMO can be used for the conversion. In step S3, the streets outside of the simulation area are eliminated from the graph representation. This confines vehicle movements in the simulation to the selected area. In step S4, the vehicles and random vehicle traffic are generated and distributed throughout the simulation area. In one embodiment, a Route Generator can be used to perform this function. In step S5, the vehicle movement in terms of (x, y) coordinates is calculated. In one embodiment, off-the-shelf tools such as TraNS and/or SUMO can be used for these calculations. In step S6, a converter can be used to transform the calculated coordinates to the QualNet format. Next, the vehicle mobility trace is ready for simulation in QualNet; this simulation is performed in step S7. Visualization of the simulation is performed in step S8.

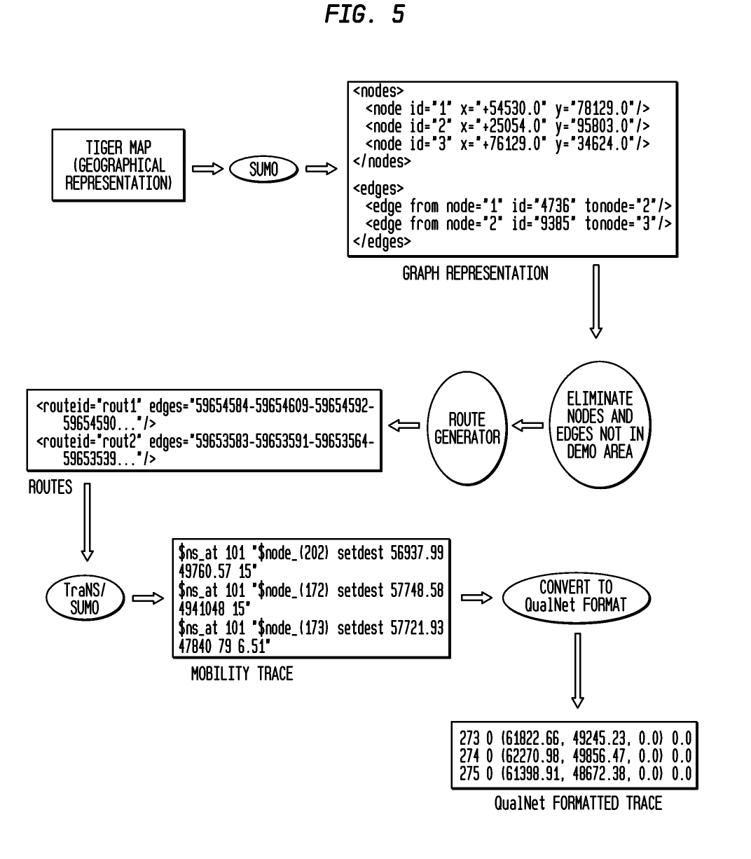

FIG. 5 shows the visualization creation process in one embodiment of the invention. Initially the simulation area is selected using TIGER® map. After the selection of a simulation area, SUMO converts the TIGER® map into a graph representation. In the embodiment shown in FIG. 5, the graph representation comprises nodes and edges which represent the physical coordinates of each node or physical, street intersection. Each node has an id with associated x and y coordinates. For example, node or street intersection with id of node id “1” has x and y coordinates of x=+54530.0 and y=78129.0. The edge with id of “4736” is from node 1 to node 2; the edge with id of “9385” is from node 2 to node 3. After the graph representation is created, the streets outside of the simulation area are eliminated from this representation. Route Generator generates routes, which are defined as edges in the graph representation. For example, route with id “route1” includes edges of 59654584-59654609-59654592-59654590 and more; these edges can be street names. TraNS is used to calculate a vehicular traffic and road network simulation environment, and SUMO calculates the vehicle movement in terms of (x, y) coordinates based on the information from TraNS. In accordance with these calculations, a mobility trace is generated. This mobility trace tells where a car is at a certain time. The car identification or node number, e.g., $node (172), identifies a node, e.g., a car, not a street intersection, and its location. Next, the calculated coordinates of the mobility trace are converted to the communication network simulation tool, e.g., QualNet, format. A QualNet formatted trace is created, and communication simulation in QualNet is performed. The QualNet formatted trace includes the car/node number, e.g., 273, 274, 275, its coordinates, e.g., (61822.66, 49245.23, 0.0) and a time stamp, e.g., 0.0. This formatted trace information serves as input to QualNet; the output from QualNet is packet exchange information among the vehicles, which is then stored in the database “DB” in FIG. 3.

This simulation platform can be used to visualize all vehicles participating in the simulation (global view) as well as the application running in individual vehicles (local view). The simulation shows how a given protocol works among cars talking to each other with both global and local (single car) views.

This simulation technique advantageously enables the user to simulate vehicular communication in any part of the world as long as a map of the area is available, put realistic traffic on the area, and visualize in-vehicle applications running in individual vehicles as well as the movement of all vehicles in the simulation area.

Various aspects of the present disclosure may be embodied as a program, software, or computer instructions embodied or stored in a computer or machine usable or readable medium, which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for vehicular networking and applications visualization, comprising:
a CPU; and
a module operable to select a simulation area, convert the selected simulation area to graph representation, eliminate streets outside the selected simulation area, generate, using the graphic representation, a plurality of vehicles and random vehicle traffic in the selected simulation area, calculate vehicle movement in coordinates, transform the calculated coordinates into a format compatible with a general purpose communication networking simulation tool, simulate, using the transformed calculated coordinates and the general purpose communication networking simulation tool, an application, and perform visualization of the simulation.

2. The system according to claim 1, wherein the application is the vehicle movement and communication among the plurality of vehicles.

3. The system according to claim 2, wherein the simulation is at least 2000 seconds and the communication is disruption tolerant.

4. The system according to claim 1, wherein the visualization of the simulation comprises a global view of all of the plurality of vehicles and one or more local views, each local view of one of the plurality of vehicles.

5. The system according to claim 1, wherein the plurality of vehicles is at least 500 vehicles.

6. The system according to claim 1, wherein the simulation area is obtained from a geographic map.

7. A method for vehicular networking and applications visualization, comprising steps of:
selecting a simulation area;
converting the selected simulation area to graph representation;
eliminating streets outside the selected simulation area;
generating, using the graph representation, a plurality of vehicles and random vehicle traffic in the selected simulation area;
calculating vehicle movement in coordinates;
transforming the calculated coordinates into a format compatible with a general purpose communication networking simulation tool;
simulating, using the transformed calculated coordinates and the general purpose communication networking simulation tool, an application; and
performing visualization of the simulation.

8. The method according to claim 7, wherein the application is the vehicle movement and communication among the vehicles.

9. The method according to claim 8, wherein the simulation is at least 2000 seconds and the communication is disruption tolerant.

10. The method according to claim 7, wherein the visualization of the simulation comprises a global view of all of the plurality of vehicles and one or more local views, each local view of one of the plurality of vehicles.

11. The method according to claim 7, wherein the plurality of vehicles is at least 500 vehicles.

12. The method according to claim 7, wherein the simulation area is obtained from a geographic map.

13. A computer readable storage medium storing a program of instructions executable by a machine to perform a method for vehicular networking and applications visualization, comprising steps of:
selecting a simulation area;
converting the selected simulation area to graph representation;
eliminating streets outside the selected simulation area;
generating, using the graphic representation, a plurality of vehicles and random vehicle traffic in the selected simulation area;
calculating vehicle movement in coordinates;
transforming the calculated coordinates into a format compatible with a general purpose communication networking simulation tool;
simulating, using the transformed calculated coordinates and the general purpose communication networking simulation tool, the vehicle movement and communication among the vehicles; and
performing visualization of the simulation.

14. The computer readable storage medium according to claim 13, wherein the application is the vehicle movement and communication among the vehicles.

15. The computer readable storage medium according to claim 14, wherein the simulation is at least 2000 seconds and the communication is disruption tolerant.

16. The computer readable storage medium according to claim 13, wherein the visualization of the simulation comprises a global view of all of the plurality of vehicles and one or more local views, each local view of one of the plurality of vehicles.

17. The computer readable storage medium according to claim 13, wherein the plurality of vehicles is at least 500 vehicles.

18. The computer readable storage medium according to claim 13, wherein the simulation area is obtained from a geographic map.
